(19) United States
(12) Patent Application Publication
(10) Pub. No.: US 2007/0169366 A1
(43) Pub. Date: Jul. 26, 2007

(54) Drying machine

(75) Inventor: Masaya Tadano, Ota-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/655,165

(22) Filed: Jan. 19, 2007

(30) Foreign Application Priority Data
Jan. 20, 2006 (JP) 12381/2006

(51) Int. Cl. F26B 21/06; F25D 17/06; F25D 21/14

(52) U.S. Cl. 34/77; 62/93; 34/78; 62/285

(57) ABSTRACT

An object is to provide a drying machine capable of effectively eliminating confinement of heat while a drying time of an object to be dried is reduced, and the drying machine includes a refrigerant circuit constituted by successively connecting a compressor, a radiator, a pressure reducing unit, an evaporator and the like in an annular form via a pipe; an air circulation path which allows an air sending unit to perform air circulation to send air from the radiator through the storage chamber to the evaporator and to again return the air to the radiator; and a heat exchange unit for performing heat exchange between an external heat medium and a refrigerant in the refrigerant circuit in a range of a refrigerant outlet side of the evaporator to a refrigerant discharge side of the compressor, the heat exchange unit being constituted of an external heat exchanger for performing heat exchange between the external heat medium and the refrigerant of an intermediate pressure section of a compressor.

### BACKGROUND OF THE INVENTION

The present invention relates to a drying machine which includes a storage chamber to store an object to be dried and which executes a drying operation of the object to be dried in this storage chamber.

Heretofore, in this type of drying machine, a drying chamber (a storage chamber) to store an object to be dried such as clothing is constituted in a rotary drum rotatably attached to a main body, and the drying chamber is connected to an air circulation path for sending air for drying. Moreover, the air heated by a radiator disposed in the air circulation path is sent to the drying chamber by a fan (air sending means) to take a moisture from the object to be dried stored in the drying chamber. Humidity (moisture) evaporated from the object to be dried is condensed and removed by an evaporator (a heat absorber). The air is heated again by the radiator, and sent to the drying chamber. This cycle is repeated. Moreover, when such a cycle is repeated, the object to be dried stored in the drying chamber is gradually dried.

In such a drying machine, when a drying operation is performed, an electric input of a compressor is gradually accumulated as heat in a refrigerant circuit and the air circulation path, thereby causing a disadvantage that the heat is confined in the drying machine. That is, when a temperature of the circulated air rises, a device is damaged. Moreover, the air discharged to the object to be dried has a high temperature. Therefore, since a quantity of heat of a refrigerant in the refrigerant circuit also increases, the temperature of the refrigerant flowing through the refrigerant circuit also rises, thereby causing problems that the device is damaged and that the object to be dried is discolored.

Moreover, in a case where the circulated air has the high temperature, since heat exchange is performed between the air and the refrigerant, the temperature of the refrigerant of the refrigerant circuit also rises. Therefore, a refrigerant pressure also increases, and the refrigerant circuit might be brought into an overload state. In consequence, in a case where a temperature of the refrigerant discharged from the compressor and having the highest temperature and pressure in the circuit reaches an upper limit value, an overload preventing unit operates to stop the compressor, and a disadvantage that the circuit is brought into such an overload state has been avoided. However, when the overload preventing unit operates in this manner, the compressor is stopped. While the compressor is stopped, the object to be dried cannot be dried. This has caused a problem that much time is required for the drying.

To solve such a disadvantage, there is developed another drying machine provided with radiation means for cooling the drying air between the radiator and the evaporator or between the drying chamber and the evaporator so that the compressor does not stop to the utmost. For example, in a case where the radiation means is disposed between the drying chamber and the evaporator, a capability of the compressor is controlled in accordance with information from state detection means for detecting a state of the drying air or the refrigerant circuit. Moreover, when the refrigerant temperature at an outlet of the compressor rises to a predetermined value, a quantity of radiant heat of the radiation means is increased to discharge the heat from the compressor.

In consequence, since the air discharged from the drying chamber is cooled, a sucked refrigerant temperature of the compressor drops. Moreover, since the sucked refrigerant temperature of the compressor drops, a temperature of the compressor itself drops. As a result, a temperature of the refrigerant discharged from the compressor also drops. In consequence, the discharge temperature can be lowered without stopping the compressor, and a drying time can be reduced (see, e.g., Japanese Patent Application Laid-Open No. 2004-236965).

However, in the above case, since the air discharged from the drying chamber is cooled, it is not possible to quickly cope with a problem of the refrigerant temperature rise at the outlet of the compressor on a high-pressure side of the refrigerant circuit. That is, a long control time is required for controlling the compressor so as to protect the discharge temperature. Eventually, control in expectation of the problem (a protecting operation such as an operation of setting the upper limit value of the discharge temperature of the compressor to be small or an operation of controlling the capability of the compressor) needs to be performed, it is difficult to sufficiently exhibit the capability of the compressor, and the drying time is not easily reduced.

### SUMMARY OF THE INVENTION

The present invention is developed to solve such a problem of a conventional technology, and an object thereof is to provide a drying machine capable of effectively eliminating confinement of heat while reducing a drying time of an object to be dried.

A drying machine of a first invention of the present application includes a storage chamber to store an object to be dried, executes a drying operation of the object to be dried in this storage chamber, and is characterized by comprising: a refrigerant circuit constituted by successively connecting a compressor, a radiator, a pressure reducing unit, an evaporator and the like in an annular form via a pipe; an air circulation path which allows air sending means to perform air circulation to send air from the radiator through the storage chamber to the evaporator and to again return the air to the radiator; and heat exchange means for performing heat exchange between an external heat medium and a refrigerant in the refrigerant circuit in a range of a refrigerant outlet of the evaporator to a refrigerant inlet of the radiator.

The drying machine of a second invention of the present application is characterized in that in the above first invention, the compressor has an intermediate pressure section, and the heat exchange means includes an external heat exchanger which causes heat exchange between the external heat medium and the refrigerant of the intermediate pressure section of the compressor.

The drying machine of a third invention of the present application is characterized by the above second invention further comprising: channel control means for controlling whether or not to pass the refrigerant through the external heat exchanger.

The drying machine of a fourth invention of the present application is characterized by the above third invention further comprising: an internal heat exchanger which causes heat exchange between the refrigerant of the intermediate pressure section of the compressor and the air in the air circulation path, wherein in a case where any refrigerant is not passed through the external heat exchanger, the refrigerant is passed through the internal heat exchanger.

The drying machine of a fifth invention of the present application is characterized in that in the above fourth invention, the internal heat exchanger is constituted integrally with the radiator.

The drying machine of a sixth invention of the present application is characterized in that in the first invention, the heat exchange means includes an external heat exchanger which causes heat exchange between the external heat medium and the refrigerant sucked into the compressor.

The drying machine of a seventh invention of the present application is characterized by the above sixth invention further comprising: channel control means for controlling whether or not to pass the refrigerant through the external heat exchanger.

The drying machine of an eight invention of the present application is characterized in that in the above inventions, the compressor is disposed in the air circulation path.

The drying machine of a ninth invention of the present application is characterized in that in the above first to seventh inventions, the compressor is disposed in the outside of the air circulation path, and a periphery of this compressor is insulated.

According to the first invention of the present application, the drying machine includes a storage chamber to store an object to be dried, which executes a drying operation of the object to be dried in this storage chamber, and further comprises: the refrigerant circuit constituted by successively connecting the compressor, the radiator, the pressure reducing unit, the evaporator and the like in the annular form via the pipe; the air circulation path which allows the air sending means to perform the air circulation to send air from the radiator through the storage chamber to the evaporator and again return the air to the radiator; and the heat exchange means for performing heat exchange between the external heat medium and the refrigerant in the refrigerant circuit in a range of the refrigerant outlet of the evaporator to the refrigerant inlet of the radiator. Since the heat exchange between the refrigerant of the refrigerant circuit and the external heat medium is performed, confinement of heat can be eliminated.

In consequence, it is not necessary to control a capability of the compressor or to stop the compressor in response to a temperature rise of the compressor. A high capability of the compressor can be maintained, and a drying time can be reduced. Especially, since the heat exchange between the external heat medium and the refrigerant of the refrigerant circuit is performed, it is possible to effectively cope with the temperature rise of the compressor.

Therefore, while the confinement of the heat is effectively eliminated, the drying time can be reduced.

Especially, as in the second invention, the compressor has the intermediate pressure section, and the heat exchange means includes the external heat exchanger which causes the heat exchange between the external heat medium and the refrigerant of the intermediate pressure section of the compressor. In this case, a discharged refrigerant temperature of the compressor can quickly and exactly be lowered. Furthermore, since the heat exchange between the external heat medium and the refrigerant of the intermediate pressure section is performed, the subsequent compressing operation of the compressor can be improved.

In the third invention of the present application, since the above second invention includes the channel control means for controlling whether or not to pass the refrigerant through the external heat exchanger. Therefore, when the channel control means does not pass the refrigerant through the external heat exchanger in an initial stage of the drying operation and does not discharge any heat, the temperature rise of drying air can be promoted. In a later stage of the drying operation, when the channel control means passes the refrigerant through the external heat exchanger to discharge the heat, the confinement of the heat can be eliminated as described above.

According to the fourth invention of the present application, the above third invention includes the internal heat exchanger which causes the heat exchange between the intermediate pressure section of the compressor and the air in the air circulation path. In a case where any refrigerant is not passed through the external heat exchanger, the refrigerant is passed through the internal heat exchanger. Therefore, a temperature of the intermediate-pressure refrigerant can be utilized in heating the drying air.

Moreover, when the internal heat exchanger is constituted integrally with the radiator as in the fifth invention of the present application, the number of components can be reduced, and a space efficiency increases.

Furthermore, in the first invention of the present application, the heat exchange means includes the external heat exchanger which causes the heat exchange between the external heat medium and the refrigerant sucked into the compressor as in the sixth invention of the present application. In this case, the discharged refrigerant temperature of the compressor can quickly and exactly be lowered. Furthermore, since the heat exchange between the medium and the refrigerant sucked into the compressor is performed, an efficiency of the compressing operation of the whole compressor can be increased.

Especially, the channel control means for controlling whether or not to pass the refrigerant through the external heat exchanger is disposed as in the seventh invention. Therefore, when the channel control means does not pass any refrigerant through the external heat exchanger in the initial stage of the drying operation and does not discharge any heat, the temperature rise of the drying air can be promoted. In the later stage of the drying operation, when the channel control means passes the refrigerant through the external heat exchanger to discharge the heat, the confinement of the heat can be eliminated as described above.

According to the eight invention of the present application, in the above inventions, the compressor is disposed in the air circulation path. Therefore, the heat released from the compressor itself can be utilized in heating the drying air. In consequence, the temperature rise of the drying air can be promoted in the initial stage of the drying operation.

According to the ninth invention of the present application, in the first to seventh inventions, the compressor is disposed in the outside of the air circulation path, and the periphery of this compressor is insulated. Therefore, it is possible to avoid in advance especially a disadvantage that the compressor is heated by the drying air having the temperature raised in the later stage of the drying operation and that the temperature in the compressor rises.

### BRIEF DESCRIPTION OF THE DRAWINGS

FIG. 1 is an internal constitution diagram of a washing and drying machine of an embodiment of the present invention;

FIG. 2 is the Mollier chart of a refrigerant circuit during a drying operation of the washing and drying machine of FIG. 1;

FIG. 3 is an explanatory view of a case where a fan is disposed in the vicinity of an external heat exchanger of the washing and drying machine of FIG. 1;

FIG. 4 is an explanatory view of a case where the external heat exchanger of the washing and drying machine of FIG. 1 is a water cooling type heat exchanger;

FIG. 5 is an explanatory view of a washing and drying machine of Embodiment 2 of the present invention;

FIG. 6 is an explanatory view of another washing and drying machine of Embodiment 2 of the present invention;

FIG. 7 is an internal constitution diagram of a washing and drying machine of Embodiment 3 of the present invention;

FIG. 8 is an explanatory view of another washing and drying machine of Embodiment 3 of the present invention;

FIG. 9 is an explanatory view of a washing and drying machine of Embodiment 4 of the present invention (applied to Embodiment 1);

FIG. 10 is an explanatory view of the washing and drying machine of Embodiment 4 of the present invention (another example applied to Embodiment 1);

FIG. 11 is an explanatory view of another washing and drying machine of Embodiment 4 of the present invention (applied to Embodiment 2);

FIG. 12 is an explanatory view of still another washing and drying machine of Embodiment 4 of the present invention (another example applied to Embodiment 2);

FIG. 13 is an explanatory view of a further washing and drying machine of Embodiment 4 of the present invention (applied to Embodiment 3);

FIG. 14 is an explanatory view of a further washing and drying machine of Embodiment 4 of the present invention (another example applied to Embodiment 3);

FIG. 15 is an internal constitution diagram of a washing and drying machine of Embodiment 5 of the present invention;

FIG. 16 is a diagram showing transitions of a drying time and a circulation temperature (air for drying) during a drying operation of the washing and drying machine of FIG. 15; and

FIG. 17 is an explanatory view of another washing and drying machine of Embodiment 5 of the present invention.

### DETAILED DESCRIPTION OF THE PREFERRED EMBODIMENTS

Next, embodiments of the present invention will be described in detail with reference to the drawings.

### Embodiment 1

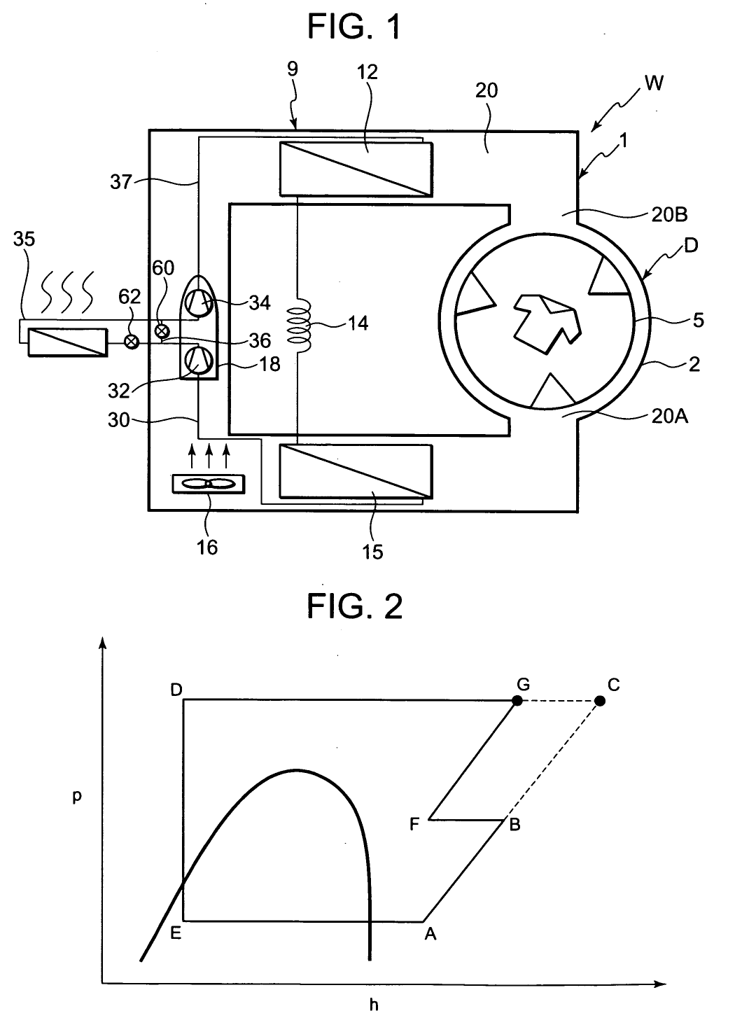

FIG. 1 shows an internal constitution diagram of a washing and drying machine W which executes a washing operation and a drying operation after the washing operation as one embodiment of a drying machine to which the present invention has been applied. The washing and drying machine W of the present embodiment is for use in washing and drying an object to be washed such as clothing (this object to be washed is an object to be dried during the drying operation). In a main body 1, a drum main body D is disposed which includes an outer drum 2 having a cylindrical shaft disposed in a horizontal direction, capable of storing water and made of a cylindrical resin; and an inner drum (a rotary drum) 5 disposed in this outer drum 2, serving as both a washing tank and a spin-drier tank and made of a cylindrical stainless steel. Moreover, in this inner drum 5, a storage chamber 7 is disposed in which the object to be washed (the object to be dried) is to be stored. This chamber also has a cylindrical shaft disposed in a horizontal direction, this rotary shaft is connected to a shaft of a driving motor (not shown) attached to a side wall of the outer drum 2, and the inner drum 5 is held in the outer drum 2 so as to be rotatable centering on the rotary shaft of the inner drum 5 connected to the shaft of the motor.

In an upper part of the main body 1, a water supply passage (not shown) is disposed as water supply means for supplying water into the inner drum 5, and one end of this water supply passage is connected to a water supply source such as city water via a water supply valve. This water supply valve is controlled to open or close by a control unit. The other end of the water supply passage is connected to the outer drum 2 to communicate with the inside of the drum. When the water supply valve is opened by the control unit, water (city water) is supplied from the water supply source to the storage chamber 7 of the inner drum 5 disposed in the outer drum 2.

Moreover, in a lower part of the main body 1, a water discharge passage (not shown) is disposed as water discharge means for discharging water from the storage chamber 7 of the inner drum 5. One end of this water discharge passage communicates with a bottommost portion of the outer drum 2 via a water discharge valve which is controlled so as to open or close by the control unit. The other end of the water discharge passage is derived from the washing and drying machine W to reach a drain ditch or the like.

A mechanical chamber 9 is constituted on a side of the drum main body D in the main body 1, and an air circulation path 20 is constituted in this mechanical chamber 9. One end of this air circulation path 20 is provided with an inlet 20A, and an evaporator 15 of a refrigerant circuit 10 described later is disposed in the air circulation path 20 in the vicinity of the inlet 20A. Moreover, the inlet 20A of this air circulation path 20 communicates with one side of the inner drum 5. The other end of the air circulation path 20 is provided with an outlet 20B, and a radiator 12 of the refrigerant circuit 10 is disposed in the air circulation path 20 in the vicinity of the outlet 20B.

Moreover, a fan 16 is disposed as air sending means in the air circulation path 20, and circulated air (air for drying) is sent from the outlet 20B of the air circulation path 20 into the storage chamber 7 of the inner drum 5. That is, the washing and drying machine W allows the fan 16 to circulate the air of the inner drum 5 through the air circulation path 20 during the drying operation to heat the air by heat exchange between the air and the radiator 12 disposed on an outlet 20B side of the air circulation path 20, and the air is then discharged into the storage chamber 7 of the inner drum 5. Moreover, the air circulated through the storage chamber 7 to dry the object to be dried is sucked from the inlet 20A into the air circulation path 20, and the air is cooled by heat exchange between the air and the evaporator 15 disposed on an inlet 20A side. After a moisture is removed, the air is again sucked into the fan 16, sent to the radiator 12 and discharged into the storage chamber 7. That is, circulation is performed by the fan 16 to send the air in the air circulation path 20 from the radiator 12 through the storage chamber 7 to the evaporator 15 and to return the air again to the radiator 12.

On the other hand, the refrigerant circuit 10 is constituted by successively a compressor 11, the radiator 12, an expansion valve 14 as a pressure reducing unit, the evaporator 15 and the like in an annular form via a pipe. Moreover, a predetermined amount of carbon dioxide (CO₂) is introduced as a refrigerant in the refrigerant circuit 10. Here, the compressor 11 for use in the present embodiment is a multistage (two stages) compression type rotary compressor provided with, in a sealed vessel 18, an electromotive element (not shown) as a driving element; and a first rotary compression element 32 (a first stage) and a second rotary compression element 34 (a second stage) which are to be driven by this electromotive element. The compressor is disposed on a downstream side (a leeward side) of the evaporator 15 and on an upstream side (a windward side) of the radiator 12 in the air circulation path 20.

Moreover, a low-pressure refrigerant is introduced from a refrigerant introduction tube 30 to the first rotary compression element 32 of the compressor 11. An intermediate-pressure refrigerant compressed by the first rotary compression element 32 is discharged once from the sealed vessel 18 via the refrigerant introduction tube 35, and then introduced into the second rotary compression element 34. A high-temperature high-pressure refrigerant gas compressed by the second rotary compression element 34 is discharged from the compressor 11 via a refrigerant discharge tube 37.

The refrigerant discharge tube 37 of this compressor 11 is connected to an inlet of the radiator 12 disposed on the outlet 20B side of the air circulation path 20. A pipe extending from this radiator 12 is connected to an inlet of the expansion valve 14, the pipe extending from the expansion valve 14 reaches an inlet of the evaporator 15 disposed on the inlet 20A side of the air circulation path 20, and an outlet of the evaporator 15 is connected to the refrigerant introduction tube 30 to reach the compressor 11.

On the other hand, between the refrigerant output of the evaporator 15 and the refrigerant inlet of the radiator 12, the washing and drying machine W includes heat exchange means for performing heat exchange between an external heat medium of the washing and drying machine W and the refrigerant of the refrigerant circuit 10. The heat exchange means of the present embodiment is constituted of an external heat exchanger 50 for performing heat exchange between the external heat medium of the washing and drying machine W and a refrigerant of an intermediate pressure section of the compressor 11. Here, the intermediate pressure section of the compressor 11 is a region from a position where the refrigerant compressed by the first rotary compression element 32 obtains an intermediate pressure and is discharged to a position where the refrigerant is sucked into the second rotary compression element 34. In the present embodiment, the intermediate pressure section is disposed in the refrigerant introduction tube 35. Therefore, the external heat exchanger 50 of the present embodiment is disposed in a middle portion of the refrigerant introduction tube 35 in the outside of the air circulation path 20. The external heat exchanger 50 of the present embodiment is an air cooling type heat exchanger. It is assumed that heat exchange is performed between the refrigerant passed through the external heat exchanger 50 and outside air as the external heat medium of the washing and drying machine W.

Moreover, the refrigerant introduction tube 35 on the upstream side of the external heat exchanger 50 is connected to one end of a bypass pipe 36. The bypass pipe 36 is a refrigerant pipe which bypasses the external heat exchanger 50, and the other end of the pipe is connected to the refrigerant introduction tube 35 on the downstream side of the external heat exchanger 50. Furthermore, valve units 60, 62 are arranged on a downstream side from the bypass pipe 36 and a connection point between the refrigerant introduction tube 35 and one end of the bypass pipe 36 on an inlet side (the upstream side) of the external heat exchanger 50, respectively. Both of the valve units 60, 62 are channel control means for controlling whether or not to pass the refrigerant through the external heat exchanger 50, and openings/closings of the valve units 60, 62 are controlled by a control unit (not shown), respectively.

It is to be noted that the above control unit is control means for operating the washing and drying machine W, and the unit controls an operation of the driving motor (not shown), the opening/closing of the water supply valve of the water supply passage, the opening/closing of the water discharge valve of the water discharge passage, an operation of the compressor 11, throttle adjustment of the expansion valve 14 and air flow rate adjustment of the fan 16.

Furthermore, the control unit controls the openings/closings of the valve units 60, 62. Specifically, to open/close the valve units 60, 62, the control unit opens/closes the valve units 60, 62 based on one of a discharged refrigerant temperature of the compressor 11, a sucked refrigerant temperature of the compressor 11, a temperature of the sealed vessel 18 of the compressor 11, a refrigerant temperature at the inlet of the expansion valve 14, a refrigerant temperature at an outlet of the expansion valve 14, a high-pressure side refrigerant pressure of the refrigerant circuit 10, a pressure of the intermediate pressure section of the refrigerant circuit 10, a refrigerant pressure of the refrigerant circuit 10 on a low-pressure side, a drying air temperature (a circulated air temperature) at an inlet of the storage chamber 7, a drying air temperature at an outlet of the storage chamber 7, a drying air temperature at the outlet of the evaporator 15 and a refrigerant temperature at the inlet of the radiator 12 to control circulation of the refrigerant through the external heat exchanger 50.

In the present embodiment, at an outlet of the compressor 11 of the refrigerant circuit 10, a refrigerant temperature sensor 70 is disposed as state detection means for detecting the temperature of the high-temperature high-pressure refrigerant discharged from the compressor 11, and the control unit opens/closes the valve units 60, 62 based on an output of the refrigerant temperature sensor 70. That is, when the discharged refrigerant temperature detected by the refrigerant temperature sensor 70 rises to a predetermined protection upper-limit temperature set beforehand, the control unit opens the valve unit 62, and closes the valve unit 60. In consequence, after the intermediate-pressure refrigerant compressed by the first rotary compression element 32 flows from the refrigerant introduction tube 35 through the valve unit 62 to the external heat exchanger 50, the refrigerant is sucked into the second rotary compression element 34.

On the other hand, when the discharged refrigerant temperature detected by the refrigerant temperature sensor 70 drops to a predetermined protection lower-limit temperature set beforehand, the control unit opens the valve unit 60, and closes the valve unit 62. In consequence, the intermediate-pressure refrigerant enters the bypass pipe 36 from the refrigerant introduction tube 35, passes through the valve unit 60 and is sucked into the second rotary compression element 34 via the refrigerant introduction tube 35 on the downstream side of the external heat exchanger 50.

Next, an operation of the washing and drying machine W constituted as described above will be described. When a predetermined amount of a detergent is introduced into the storage chamber 7 of the inner drum 5 in accordance with an amount of the object to be washed and a power switch and a start switch of operation switches (not shown) are operated, the control unit starts the washing operation. In consequence, the control unit opens the water supply valve of the water supply passage (not shown), and opens the water supply passage to supply water from the water supply source into the storage chamber 7 of the inner drum 5. It is to be noted that at this time the water discharge valve of the water discharge passage is closed by the control unit.

When a predetermined amount of the water is accumulated in the storage chamber 7 of the inner drum 5, the control unit closes the water supply valve to block the water supply passage. In consequence, the supply of the water from the water supply source is stopped.

Next, the control unit energizes and starts the driving motor, the shaft rotates, the inner drum 5 attached to the shaft starts rotating in the outer drum 2, and a washing process of the washing operation is started.

After elapse of a predetermined time from start of the washing process, the control unit stops the driving motor, and opens the water discharge valve of the water discharge passage to discharge the water (washing water) from the storage chamber 7 of the inner drum 5 (i.e., the outer drum 2).

Moreover, when the water is discharged from the storage chamber 7 of the inner drum 5, the control unit operates the driving motor again to spin-dry the washed object. After this spin-drying is executed for a predetermined time, the control unit closes the water discharge valve of the water discharge passage.

Next, the control unit shifts to a rinsing process, and opens the water supply valve of the water supply passage to open the water supply passage. In consequence, the water is supplied again from the water supply source to the storage chamber 7 of the inner drum 5. When a predetermined amount of the water is supplied to the storage chamber 7 of the inner drum 5, the control unit closes the water supply valve, and blocks the water supply passage. In consequence, the supply of the water from the water supply source is stopped.

Moreover, after the rotating operation of the driving motor is repeated for a predetermined time to perform rinsing, the control unit stops the driving motor, and opens the water discharge valve of the water discharge passage to discharge rinsing water from the storage chamber 7 to the water discharge passage. When the rinsing water is discharged from the storage chamber 7, the control unit operates the driving motor again, and rotates the inner drum 5 in the same manner as described above to shift to a spin-drying process in which the washed object is spin-dried. Furthermore, after this spin-drying process is executed for a predetermined time, the control unit rotates the inner drum 5 by the driving motor to shift to the drying operation.

During this drying operation, the control unit starts the fan 16 in the air circulation path 20 and the compressor 11 of the refrigerant circuit 10. In consequence, the compressor 11 starts compressing the refrigerant. That is, a low-temperature low-pressure refrigerant gas is sucked into the first rotary compression element 32 of the compressor 11 (a state A of the Mollier chart shown in FIG. 2). Moreover, the refrigerant gas compressed by the first rotary compression element 32 to obtain the intermediate pressure is brought into a state B shown in FIG. 2, and discharged to the refrigerant introduction tube 35. At this time, in a case where the discharged refrigerant temperature of the compressor 11 detected by the refrigerant temperature sensor 70 is lower than the predetermined protection upper-limit temperature set beforehand, the control unit opens the valve unit 60 of the bypass pipe 36, and closes the valve unit 62. Therefore, the intermediate-pressure refrigerant discharged to the refrigerant introduction tube 35 does not flow through the external heat exchanger 50, and all of the refrigerant passes through the bypass pipe 36 and is sucked into the second rotary compression element 34 (the state B remains as shown by a broken line of FIG. 2).

In a case where the discharged refrigerant temperature of the compressor 11 detected by the refrigerant temperature sensor 70 is lower than the predetermined protection upper-limit temperature set beforehand in this manner, the refrigerant of the refrigerant circuit 10 does not radiate in the external heat exchanger 50. Therefore, as shown by a broken line in FIG. 2, the refrigerant temperature can be set to be high in an early stage.

On the other hand, the intermediate-pressure refrigerant gas sucked into the second rotary compression element 34 is compressed in the element to form a high-temperature high-pressure refrigerant gas (a state C of FIG. 2), and the gas is discharged from the compressor 11 via the refrigerant discharge tube 37. Moreover, the refrigerant discharged from the compressor 11 enters the radiator 12, radiates in the radiator to achieve a state D shown in FIG. 2, and then reaches the expansion valve 14. Furthermore, the pressure of the refrigerant is reduced by the expansion valve 14. In this process, the refrigerant is liquefied (a state E shown in FIG. 2), then enters the evaporator 15, absorbs heat from a surrounding area in the evaporator, evaporates and is sucked into the compressor 11. This circulation is performed (the state A shown in FIG. 2).

Moreover, when the fan 16 operates, the drying air heated to reach a high temperature by the radiant heat from the high-temperature high-pressure refrigerant gas in the radiator 12 is sent toward the outlet 20B of the air circulation path 20, and discharged from the outlet 20B to the storage chamber 7. The drying air discharged to the storage chamber 7 warms the object to be dried stored in the inner drum 5 (the storage chamber 7) to evaporate a moisture, and the object to be dried is dried. The humidity-containing air which has dried the object to be dried flows through the storage chamber 7, is discharged from the inner drum 5, returns from the inlet 20A to the air circulation path 20 and passes through the evaporator 15 disposed in the path.

At this time, the moisture (the moisture evaporated from the object to be dried) contained in the air from the storage chamber 7 is condensed on the surface of the evaporator 15 while passing through the evaporator 15, and the moisture falls as water droplets. The fallen water droplets are discharged from the water discharge passage to the external drain ditch or the like via a drain pipe (not shown). The air from which the humidity has been removed to dry by this evaporator 15 is sucked into the fan 16, then discharged toward the compressor 11, and passes around the compressor 11. At this time, in the present embodiment, the compressor 11 is disposed in the air circulation path 20. Therefore, when the air cooled by the evaporator 15, sucked into the fan 16 and discharged is passed around the compressor 11, the compressor 11 heated by the operation can be cooled. Furthermore, the radiant heat from the compressor 11 itself can be utilized in heating the drying air. In consequence, a temperature rise of the drying air in an initial stage of the drying operation can be promoted.

Moreover, the circulated air (the drying air) which has cooled the compressor 11 enters the radiator 12, is heated, exits from the outlet 20B of the air circulation path 20, is discharged into the storage chamber 7 of the inner drum 5, takes the moisture from the object to be dried in the storage chamber 7 and dries the object to repeat this circulation.

When such a drying operation is executed, an electric input of the compressor 11 is gradually accumulated in the refrigerant circuit 10 or the air circulation path 20 during the drying operation, thereby causing a disadvantage that the heat is confined in the washing and drying machine W. In a conventional washing and drying machine W, it is difficult to cope with such confinement of the heat, and the washing and drying machine might have a breakdown, or very high-temperature air might be discharged to the storage chamber to discolor the object to be dried.

Moreover, when the temperature of the circulated air rises, the refrigerant temperature in the refrigerant circuit also rises. Therefore, for example, the refrigerant pressure on the high-pressure side abnormally rises, and the refrigerant circuit might be brought into an overload state. To solve the problem, in the conventional washing and drying machine, when the discharge temperature of the compressor on the high-pressure side in the refrigerant circuit reaches an upper limit value, an overload preventing unit operates to stop the compressor, and a disadvantage of the overload state has been avoided. However, while the overload preventing unit operates to stop the compressor, the object to be dried cannot be dried. This has caused a problem that much drying time is required.

To solve the problem, another washing and drying machine is developed which is provided with radiation means for cooling the refrigerant supplied from the radiator to the evaporator or the drying air sent from the storage chamber to the evaporator. The refrigerant or the drying air is cooled by the radiation means. Moreover, the number of rotations of the compressor is controlled. In consequence, the stop of the compressor is avoided to the utmost.

In this case, for example, when the radiation means for releasing the heat from the circulated air sent from the storage chamber to the evaporator is disposed, the air exiting from the storage chamber is first cooled. With this cooling, the sucked refrigerant temperature of the compressor drops. Subsequently, since the sucked refrigerant temperature of the compressor drops and the temperature of the refrigerant discharged from the compressor finally drops, it is not possible to quickly cope with the refrigerant temperature rise at the outlet of the compressor.

Moreover, even when radiation means for cooling the refrigerant is disposed between the radiator and the evaporator, the temperature of the refrigerant which enters the evaporator drops. With this drop, the sucked refrigerant temperature of the compressor drops. Subsequently, since the sucked refrigerant temperature of the compressor drops, the temperature of the refrigerant discharged from the compressor finally drops. Therefore, it is not possible to quickly cope with the refrigerant temperature rise at the outlet of the compressor.

Therefore, since a long time for protection of the discharge temperature of the compressor is required, eventually, control in expectation of the time (a protecting operation such as an operation of setting the upper limit value of the discharge temperature of the compressor to be small or an operation of controlling a capability of the compressor) needs to be performed, and it has been difficult to sufficiently exhibit the capability of the compressor. Therefore, the drying time of the object to be dried cannot effectively be reduced.

However, in the washing and drying machine W of the present embodiment, when the discharged refrigerant temperature of the compressor 11 detected by the refrigerant temperature sensor 70 rises to a predetermined protection upper-limit temperature set beforehand, the control unit closes the valve unit 60 of the bypass pipe 36, and opens the valve unit 62. In consequence, all of the intermediate-pressure refrigerant discharged to the refrigerant introduction tube 35 (the intermediate pressure section) flows through the external heat exchanger 50. Moreover, the refrigerant which has entered the external heat exchanger 50 has its heat taken to release the heat by heat exchange between the refrigerant and the outside air, and achieves a state F shown in FIG. 2. Subsequently, the refrigerant which has exited from the external heat exchanger 50 is sucked into the second rotary compression element 34, compressed and discharged from the compressor 11. In consequence, the discharged refrigerant temperature of the compressor 11 drops as shown by G in FIG. 2.

Thus, the heat exchange is caused between the outside air as the external heat medium and the refrigerant in the external heat exchanger 50, the heat of the refrigerant can be discarded to the outside air, and the confinement of the heat can be eliminated. Especially, when the refrigerant of the intermediate pressure section is allowed to radiate as in the present embodiment, the discharged refrigerant temperature of the compressor 11 can quickly and exactly be lowered. Therefore, without controlling the capability of the compressor 11 or stopping the compressor as in a conventional technology, the high capability of the compressor 11 can be maintained. In consequence, the drying time can be reduced.

Moreover, as in the present embodiment, owing to the heat exchange between the outside air and the refrigerant of the intermediate pressure section of the compressor 11, the temperature of the refrigerant sucked into the second rotary compression element 34 can be lowered. In consequence, a compressing operation of the second rotary compression element 34 can be improved.

Furthermore, when the valve units 60, 62 are arranged as the channel control means and the refrigerant circulation through the external heat exchanger 50 is controlled by switching of the valve unit as in the present embodiment, any refrigerant is not passed through the external heat exchanger 50 in the initial stage of the operation, and any heat is not discharged. In consequence, the temperature rise of the drying air can be promoted, and this can contribute to the reduction of the drying time.

On the other hand, in an only case where the discharged refrigerant temperature of the compressor 11 detected by the refrigerant temperature sensor 70 rises to the predetermined protection upper-limit temperature set beforehand, the refrigerant is passed through the external heat exchanger 50 to discharge the heat. In consequence, a disadvantage due to the confinement of the heat can be eliminated.

On the other hand, when the discharged refrigerant temperature of the compressor 11 detected by the refrigerant temperature sensor 70 drops to a predetermined protection lower-limit temperature set beforehand, the control unit opens the valve unit 60 and closes the valve unit 62 to stop the refrigerant circulation through the external heat exchanger 50. In consequence, the refrigerant compressed by the first rotary compression element 32 does not flow through the external heat exchanger 50, and all of the refrigerant is sucked into the second rotary compression element 34 via the bypass pipe 36.

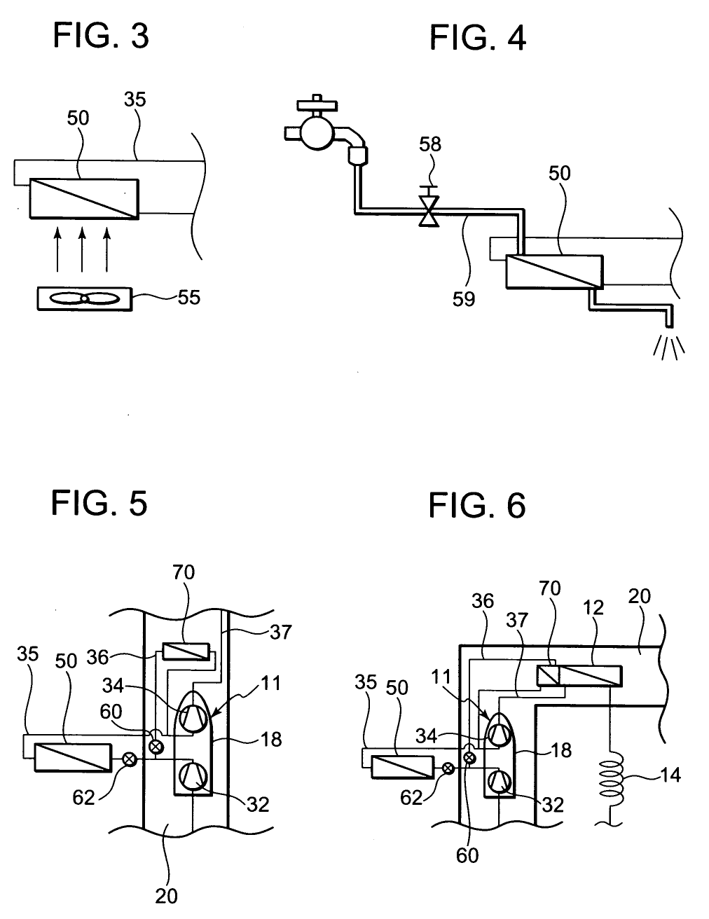

It is to be noted that in the present embodiment, it has been described that the heat exchange between the refrigerant and the outside air is caused in the external heat exchanger 50, but in the present invention, the heat medium subjected to the heat exchange between the refrigerant and the medium is not limited to the outside air, any medium such as water or brine may be used as long as the heat exchange between the refrigerant and the medium is possible. In the present embodiment, it has been described that the refrigerant is allowed to naturally radiate in the external heat exchanger 50, but the present invention is not limited to this embodiment. As shown in FIG. 3, a fan 55 may be disposed in the vicinity of the external heat exchanger 50, and an air flow rate of the fan 55 may be adjusted to thereby control a quantity of radiant heat in the external heat exchanger 50. As shown in FIG. 4, a water cooling type heat exchanger may be constituted, and an amount of the water flowing through the external heat exchanger 50 may be adjusted by a water supply valve 58 to control the quantity of radiant heat. It is to be noted that in the water cooling type heat exchanger shown in FIG. 4, a water supply passage 59 is formed in which heat exchange between the refrigerant flowing through the external heat exchanger 50 and water is possible, and one end of this water supply passage 59 is connected to a water supply source such as city water via the water supply valve 58. Moreover, it is constituted that the other end of the water supply passage 59 is derived from the washing and drying machine W to reach the drain ditch or the like.

It is assumed that the control of the quantity of radiant heat in the above case is performed in an only case where the refrigerant is passed through the external heat exchanger 50. Specifically, when the refrigerant temperature reaches the protection upper-limit temperature in response to an output of the refrigerant temperature sensor 70, the operation of the fan 55 is stopped, or the water supply valve 58 is totally closed, and the refrigerant flowing through the external heat exchanger 50 is allowed to naturally radiate. Subsequently, when the refrigerant temperature detected by the refrigerant temperature sensor 70 further rises to a first threshold value higher than the protection upper-limit temperature, the control unit operates the fan 55 at a low speed, or slightly opens the water supply valve 58 to increase the quantity of radiant heat in the external heat exchanger 50. Furthermore, when the refrigerant temperature rises to a second threshold value higher than the first threshold value, the control unit operates the fan 55 at a high speed, or further opens the water supply valve 58 to further increase the quantity of radiant heat in the external heat exchanger 50. When the quantity of radiant heat in the external heat exchanger 50 is controlled in stages, the confinement of the heat can effectively be eliminated without influencing the drying of the object to be dried.

Furthermore, in the present embodiment, it is assumed that the number of the rotations of the compressor 11 is not controlled. However, in a case where the discharged refrigerant temperature of the compressor 11 rises even if the quantity of radiant heat is set to be large as described above (the fan 55 is rotated at the high speed or the amount of the water is increased), the number of the rotations of the compressor 11 may be controlled (the control to lower the number of the rotations) in a range in which a drying performance does not deteriorate.

In addition, in the present embodiment, the bypass pipe 36 is disposed which extends around the external heat exchanger 50 to control the opening/closing of the valve units 60, 62 as the channel control means. In consequence, the circulation of the refrigerant through the external heat exchanger 50 is controlled, but the present invention is not limited to this embodiment. The present invention is effective even if the bypass pipe 36 and the valve units 60, 62 are not arranged. In this case, the fan 55 is disposed in the vicinity of the external heat exchanger 50. Alternatively, the present invention is constituted as the water cooling type heat exchanger in which the refrigerant hardly radiates in the external heat exchanger 50 in a state in which the operation of the fan 55 is stopped or the water supply valve 58 is closed. Moreover, when the refrigerant is allowed to radiate, the operation of the fan 55 is started or the water supply valve 58 is opened to thereby start the radiation of the refrigerant in the external heat exchanger 50. Even in such a case, when any heat is not discharged in the external heat exchanger 50 in the initial stage of the drying operation and the heat is discharged in an only latter stage of the drying operation in the same manner as in the above embodiment, the object to be dried can be dried in the early stage while effectively eliminating the confinement of the heat.

### Embodiment 2

The above embodiment may be provided with an internal heat exchanger 90 for performing heat exchange between a refrigerant of an intermediate pressure section of a compressor 11 and air in an air circulation path 20 as shown in FIG. 5, and a bypass pipe 36 may be disposed so as to pass through the internal heat exchanger 90. In a case where any refrigerant is not passed through an external heat exchanger 50, the refrigerant may be passed through the internal heat exchanger 90.

When any refrigerant is not passed through the external heat exchanger 50, the refrigerant is passed through the internal heat exchanger 90 to cause the heat exchange between the refrigerant of the intermediate pressure section of the compressor 11 and the air in the air circulation path 20. In consequence, drying air in the air circulation path 20 can be heated by the intermediate-pressure refrigerant.

Thus, when the intermediate-pressure refrigerant is passed through the internal heat exchanger 90 to utilize a temperature of the refrigerant in heating the drying air in the air circulation path 20, the temperature of the drying air can rise. Especially, the refrigerant flows through the internal heat exchanger 90 because a discharged refrigerant temperature of the compressor 11 detected by a refrigerant temperature sensor 70 is lower than a predetermined protection upper-limit temperature set beforehand. Therefore, for example, in an initial stage of a drying operation having a state in which circulated air has a low temperature, when the refrigerant is passed through the internal heat exchanger 90, the drying air can be heated to reach a high temperature in an early stage. A drying time can be reduced, and a drying efficiency can be raised.

Moreover, when the internal heat exchanger 90 is constituted integrally with a radiator 12 as shown in FIG. 6, the number of components can be reduced, and a space efficiency can be increased.

### Embodiment 3

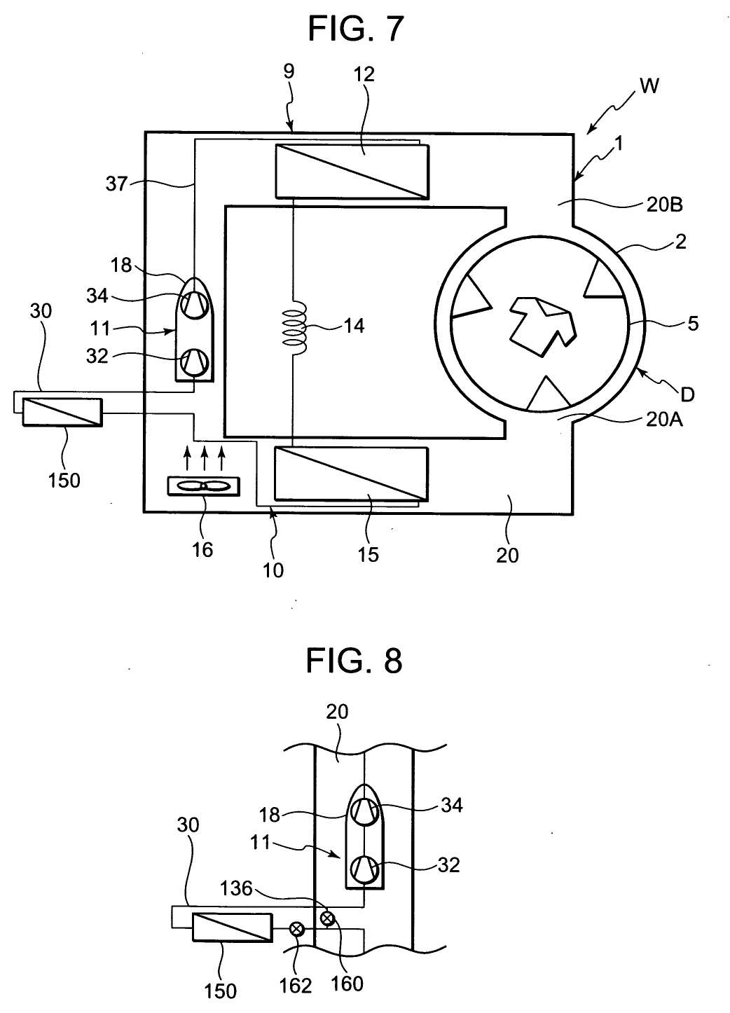

Next, another embodiment of a drying machine to which the present invention has been applied will be described with reference to an internal constitution diagram of a washing and drying machine W shown in FIG. 7. It is to be noted that in FIG. 7, components denoted with the same reference numerals as those of FIGS. 1 to 6 produce identical or similar effects, and description thereof is omitted.

Heat exchange means of the present embodiment is constituted of an external heat exchanger 150 for performing heat exchange between outside air as an external heat medium and a refrigerant sucked into a compressor 11. Specifically, the external heat exchanger 150 is disposed midway in a refrigerant introduction tube 30. The external heat exchanger 150 is disposed in the outside of an air circulation path 20 in the same manner as in the external heat exchanger 50 of the above embodiment.

Next, an operation of the washing and drying machine W of the present embodiment during a drying operation will be described. It is to be noted that processes (a washing process, a rinsing process, a spin-drying process, etc.) before the drying operation are the same as those of Embodiment 1 described above, and description thereof is therefore omitted. During the drying operation, a control unit starts a fan 16 in the air circulation path 20 and a compressor 11 of a refrigerant circuit 10. In consequence, the compressor 11 starts compression of the refrigerant.

That is, a low-temperature low-pressure refrigerant gas is sucked into a first rotary compression element 32 of the compressor 11. Moreover, the refrigerant gas compressed by the first rotary compression element 32 to obtain an intermediate pressure is sucked into a second rotary compression element 34, and compressed by the element to form a high-temperature high-pressure refrigerant gas. The gas is discharged from the compressor 11 via a refrigerant discharge tube 37. Moreover, the refrigerant discharged from the compressor 11 enters a radiator 12, radiates in the radiator, and then reaches an expansion valve 14. Furthermore, the pressure of the refrigerant is reduced by the expansion valve 14. In the process, the refrigerant is liquefied, and then enters an evaporator 15. The refrigerant absorbs heat from a surrounding area in the evaporator, and evaporates. The refrigerant exiting from the evaporator 15 enters the external heat exchanger 150. The refrigerant which has entered the external heat exchanger 150 is subjected to heat exchange between the refrigerant and surrounding air (the outside air), and radiates. In consequence, a temperature of the refrigerant sucked into the compressor 11 drops.

The refrigerant cooled by the external heat exchanger 150 repeats a cycle of being sucked into the first rotary compression element 32 of the compressor 11. Even in a case where the heat exchange means is constituted of the external heat exchanger 150 for performing the heat exchange between the outside air and the refrigerant sucked into the compressor 11, the external heat exchanger 150 can perform the heat exchange between the refrigerant and the outside air to discard the heat of the refrigerant to the outside air, and the confinement of the heat can be eliminated. Especially, a discharged refrigerant temperature of the compressor 11 can quickly and precisely be lowered. Therefore, without controlling a capability of the compressor 11 or stopping the compressor as in a conventional technology, the high capability of the compressor 11 can be maintained. In consequence, a drying time can be reduced.

Moreover, as in the present embodiment, owing to the heat exchange between the outside air and the refrigerant sucked into the compressor 11, the whole compressor 11 can be cooled. In consequence, an efficiency of a compressing operation of the compressor 11 can be raised.

It is to be noted that even in the present embodiment, channel control means such as a bypass pipe 136 disposed around the external heat exchanger 150 and valve units 160, 162 may be arranged to open/close the valve units 160, 162 by the control unit as in Embodiment 1, and it may be controlled whether or not to pass the refrigerant through the external heat exchanger 150. In consequence, when refrigerant circulation through the external heat exchanger 150, any refrigerant is not passed through the external heat exchanger 150 in an initial stage of the drying operation, and any heat is not discharged. A temperature rise of the drying air can then be promoted, and this can contribute to the reduction of the drying time. On the other hand, when the refrigerant is passed through the external heat exchanger 150 in a later stage of the drying operation to discharge the heat, a disadvantage due to the confinement of the heat can be eliminated.

Furthermore, in the present embodiment, it has been described that the refrigerant is allowed to naturally radiate in the external heat exchanger 150, but the present invention is not limited to this embodiment. As shown in FIG. 3 described above, to control a quantity of radiant heat of the refrigerant, a fan 55 may be disposed in the vicinity of the external heat exchanger 150, and an air flow rate of the fan 55 may be adjusted to thereby control the quantity of radiant heat in the external heat exchanger 150. As shown in FIG. 4, a water cooling type heat exchanges may be constituted, an amount of water flowing through the external heat exchanger 150 may be adjusted by a water supply valve 58 to control the quantity of radiant heat. It is to be noted that regarding the control in this case, the quantity of radiant heat in the external heat exchanger 150 may be controlled in stages as described above. Even when the quantity of radiant heat in the external heat exchanger 150 is set to be largest and the confinement of the heat is not eliminated yet, control of the number of rotations of the compressor 11 (control to reduce the number) may be performed in a range in which a drying performance does not deteriorate. It is to be noted that in the present embodiment, the compressor 11 is not limited to a two-stages compression type compressor. The present invention is effective even when a single-stage compression type compressor is used.

### Embodiment 4

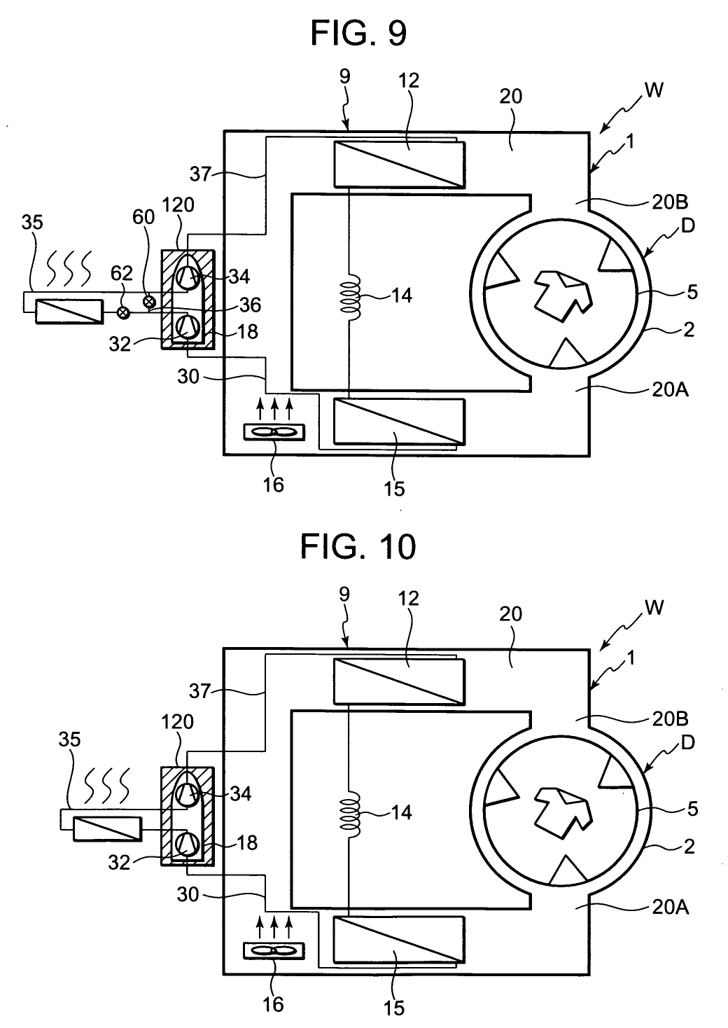

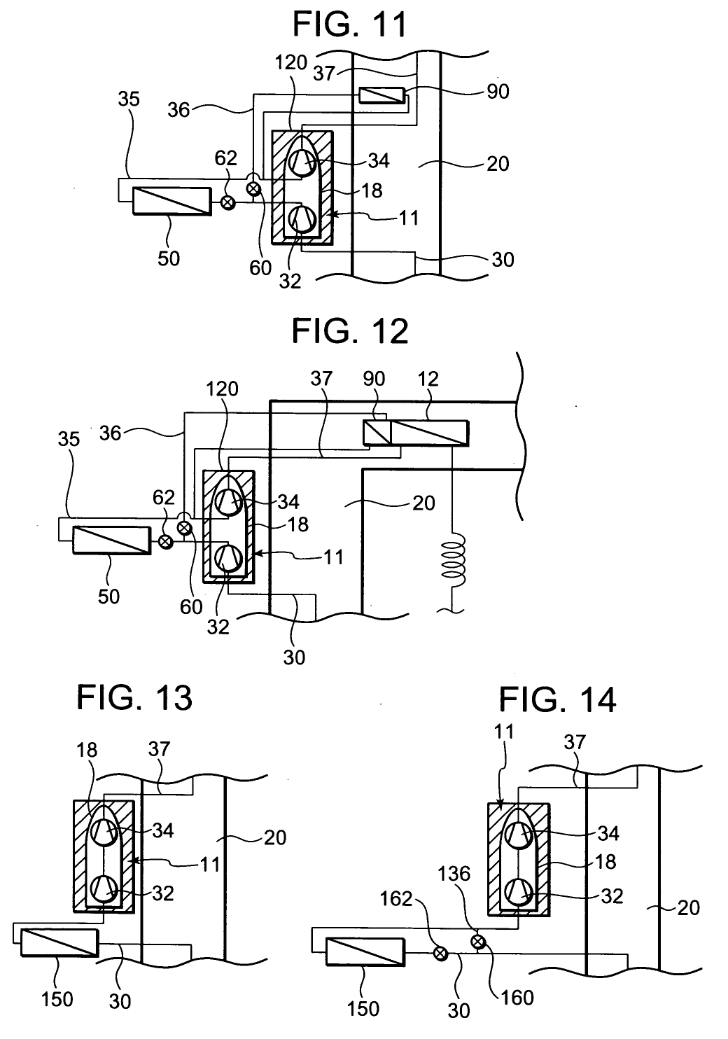

It is to be noted that in the above embodiments, it has been described that a compressor 11 is disposed in an air circulation path 20, but the compressor 11 may be disposed in the outside of the air circulation path 20. FIGS. 9 and 10 show that the compressor 11 of a washing and drying machine W of Embodiment 1 is disposed in the outside of the air circulation path 20, FIG. 9 shows that valve units 60, 62 are arranged as channel control means (i.e., the compressor 11 of the washing and drying machine W of FIG. 1 is disposed in the outside of the air circulation path 20), and FIG. 10 is an internal constitution diagram of a case where any channel control means is not disposed. FIGS. 11 and 12 are diagrams in which the compressor 11 of the washing and drying machine W of Embodiment 2 is disposed in the outside of the air circulation path 20, FIG. 11 is a diagram of a case where the compressor 11 of the washing and drying machine W of FIG. 5 is disposed in the outside of the air circulation path 20, and FIG. 12 shows a diagram of a case where the compressor 11 of the washing and drying machine W including an internal heat exchanger 90 of FIG. 6 constituted integrally with a radiator 12 is disposed in the outside of the air circulation path 20. Furthermore, FIGS. 13 and 14 are diagrams of a case where the compressor 11 of the washing and drying machine W of Embodiment 3 is disposed in the outside of the air circulation path 20, FIG. 13 shows that any channel control means is not disposed, and FIG. 14 shows that valve units 160, 162 are arranged as channel control means. It is to be noted that in FIGS. 9 to 14, components denoted with the same reference numerals as those of FIGS. 1 to 8 produce identical or similar effects, and description thereof is omitted.

In FIGS. 9 to 14, the compressor 11 is disposed in the outside of the air circulation path 20, and a periphery of the compressor 11 is insulated from the-outside. That is, a sealed vessel 18 constituting an outer contour of the compressor 11 of the present embodiment is disposed in an external insulation space 120 of the air circulation path 20. When the compressor 11 is disposed in the outside of the air circulation path 20 and the periphery of the compressor is insulated as in the present embodiment, the compressor 11 is heated by air for drying having its temperature raised in a later stage of a drying operation, and the temperature in the compressor 11 rises. In consequence, a disadvantage that the rise of the refrigerant embodiment is caused can be avoided in advance.

### Embodiment 5

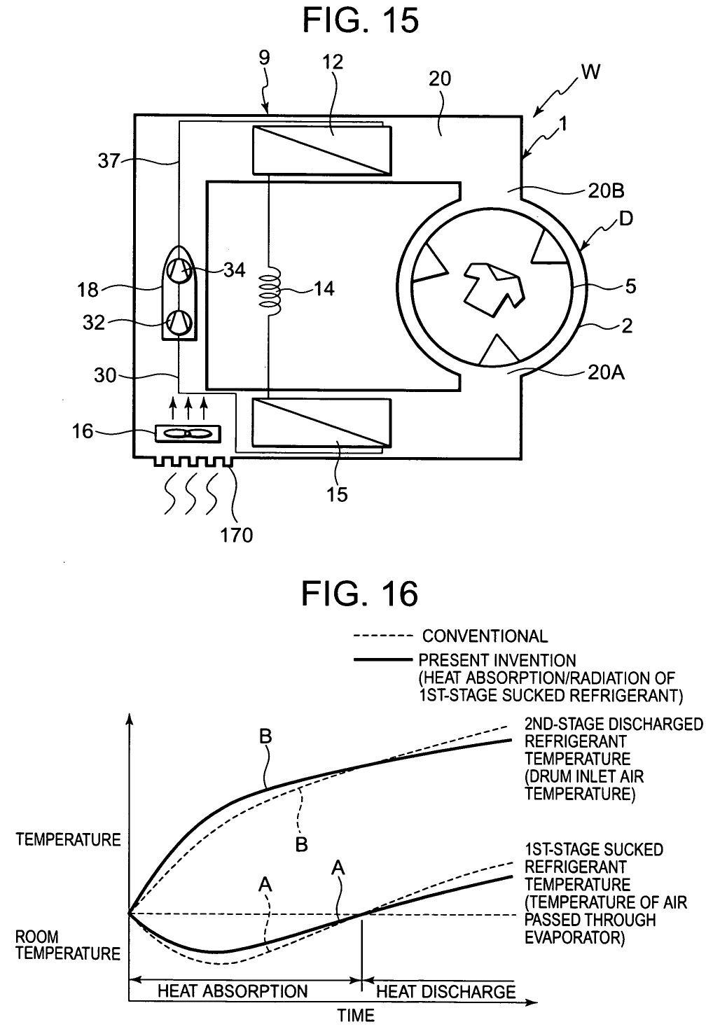

Next, another embodiment of a drying machine to which the present invention has been applied will be described with reference to an internal constitution diagram of a washing and drying machine W shown in FIG. 15. It is to be noted that in FIG. 15, components denoted with the same reference numerals as those of FIGS. 1 to 14 produce identical or similar effects, and description thereof is omitted.

In the present embodiment, heat exchange means is constituted of a heat exchanger 170 for performing heat exchange between an external heat exchange medium and air in an air circulation path 20, and the means is disposed in the air circulation path 20 from a downstream side (an air outlet) of an evaporator 15 to an upstream side (an air inlet) of a radiator 12.

The heat exchanger 170 is disposed in a position having the lowest temperature in the air circulation path 20 on the upstream side of the compressor 11 on the downstream side of the evaporator 15. Therefore, in a case where a temperature of drying air cooled by the evaporator 15 is lower than that of outside air (room temperature), when the heat exchanger 170 performs the heat exchange between the drying air and the outside air, heat is taken from the outside air to heat the drying air. Therefore, in a situation in which the temperature in the air circulation path 20 is low as in an initial stage of a drying operation, the temperature of the circulated air cooled by the evaporator 15 is as low as about +15° C. Therefore, in the heat exchanger 170, the heat is absorbed from the outside air as an external heat medium.

On the other hand, in a situation in which the temperature in the air circulation path 20 is high as in a later stage of the drying operation, the circulated air passed through the evaporator 15 has a temperature of about +50° C. Since the circulated air temperature is higher than that of the output air, the heat exchanger 170 discharge the heat (radiation) to the outside air.

Next, an operation of a washing and drying machine W of the present embodiment constituted as described above during the drying operation will be described. It is to be noted that processes (a washing process, a rinsing process, a spin-drying process, etc.) before the drying operation are the same as those of Embodiment 1 described above, and description thereof is therefore omitted. During the drying operation, a control unit starts a fan 16 in the air circulation path 20 and the compressor 11 of a refrigerant circuit 10. In consequence, the compressor 11 starts compression of the refrigerant.

That is, a low-temperature low-pressure refrigerant gas is sucked into a first rotary compression element 32 of the compressor 11. Moreover, the refrigerant gas compressed by the first rotary compression element 32 to obtain an intermediate pressure is sucked into a second rotary compression element 34, and compressed by the element to form a high-temperature high-pressure refrigerant gas. The gas is discharged from the compressor 11 via a refrigerant discharge tube 37. Moreover, the refrigerant discharged from the compressor 11 enters the radiator 12, radiates in the radiator, and then reaches an expansion valve 14. Furthermore, the pressure of the refrigerant is reduced by the expansion valve 14. In the process, the refrigerant is liquefied, and then enters the evaporator 15.

The refrigerant which has entered the evaporator 15 absorbs heat from a surrounding area in the evaporator, and evaporates. Subsequently, the refrigerant is sucked into the first rotary compression element 32 of the compressor 11 via a refrigerant introduction tube 30. This cycle is repeated.

Moreover, when the fan 16 is operated, the drying air heated by radiant heat of the high-temperature high-pressure refrigerant gas in the radiator 12 to obtain a high temperature is sent toward an inlet 20A of the air circulation path 20, and discharged from an outlet 20B to a storage chamber 7. The drying air discharged to the storage chamber 7 warms an object to be dried stored in an inner drum 5 (the storage chamber 7) to evaporate a moisture, and the object to be dried is dried. The humidity-containing air which has dried the object to be dried flows through the storage chamber 7, is discharged from the inner drum 5, returns from the inlet 20A to the air circulation path 20 and passes through the evaporator 15 disposed in the path.

At this time, the moisture (the moisture evaporated from the object to be dried) contained in the air from the storage chamber 7 is condensed on the surface of the evaporator 15 while passing through the evaporator 15, and the moisture falls as water droplets. The fallen water droplets are discharged from a water discharge passage to an external drain ditch. or the like via a drain pipe (not shown). The air from which humidity has been removed to dry by this evaporator 15 next passes through the heat exchanger 170.

Here, the temperature of the refrigerant during the drying operation transits with an elapse of time as shown in FIG. 16. In FIG. 16, a solid line A shows a transition of a temperature (a sucked refrigerant temperature of a first stage) of the refrigerant sucked into the first rotary compression element 32 in a case where the present invention is applied. It is considered that this indicates substantially the same behavior as that of a temperature transition of the drying air passed through the evaporator 15. A solid line B shows a transition of a discharged refrigerant temperature (a discharged refrigerant temperature of a second stage) of the second rotary compression element 34 in a case where the present invention is applied. It is considered that this indicates substantially the same behavior as that of the temperature transition of the drying air discharged into the storage chamber 7. A broken line A shows a transition of a temperature (a sucked refrigerant temperature of a first stage) of a refrigerant sucked into a first rotary compression element in a conventional washing and drying machine, and a broken line B shows a transition of a discharged refrigerant temperature (a discharged refrigerant temperature of a second stage) of a second rotary compression element in the conventional washing and drying machine. As shown in FIG. 16, in the initial stage of the drying operation, the temperature of the drying air passed through the evaporator 15 disposed in the air circulation path 20 is lower than that of the outside air (room temperature +20° C. to +25° C.). Therefore, when the heat exchanger 170 performs heat exchange between the drying air and the outside air, heat is absorbed from the outside air. In consequence, as shown by the solid line B in FIG. 16, the temperature of the refrigerant discharged from the second rotary compression element 34 in the initial stage of the drying operation can be raised, and a temperature rise of the drying air discharged to the storage chamber 7 can be promoted. Therefore, a drying efficiency of an object to be washed can be improved.

Moreover, the drying air passed through the heat exchanger 170 and heated is sucked into the fan 16, then discharged toward the compressor 11, passes around the compressor 11, then enters the radiator 12 to be heated, exits from the outlet 20B of the air circulation path 20, is discharged into the storage chamber 7 of the inner drum 5, and takes the moisture from the object to be dried in the storage chamber 7 to dry the object. This circulation is repeated.

When such a drying operation is executed, an electric input of the compressor 11 is gradually accumulated in the refrigerant circuit 10 or the air circulation path 20 during the drying operation as described above. In consequence, when the temperature of the drying air passed through the evaporator 15 is higher than that of the outside air as an external heat medium, the heat exchanger 170 performs heat exchange between the drying air and the outside air. In consequence, the heat is taken from the outside air to cool the drying air. Therefore, the drying air can discharge its heat to the outside. That is, in the later stage of the drying operation, the temperature of the drying air rises as described above. Even after the drying air passes through the evaporator 15, the temperature reaches about +50° C., thereby generating a disadvantage that confinement of the heat is caused. However, according to the present embodiment, as apparent from the solid lines A, B of FIG. 16, the heat exchanger 170 can discard the heat of the drying air to the outside air. Therefore, the temperature of the refrigerant sucked into the first rotary compression element 32 can be lowered.

In consequence, as shown by the solid line B of FIG. 16, even the rise of the temperature of the refrigerant discharged from the second rotary compression element 34 can be suppressed to the utmost. Therefore, suck confinement of the heat can be eliminated or prevented. In consequence, without controlling a capability of the compressor 11 or stopping the compressor as in a conventional technology, a high capability of the compressor 11 can be maintained. Therefore, the drying time can be reduced.

Especially, according to the heat exchanger 170 of the present embodiment, the heat is taken from the outside air to promote the temperature rise of the drying air in a first stage of the drying operation. Moreover, the heat is discarded to the outside air in the later stage of the drying operation, and the confinement of the heat can be eliminated. Since the temperature of the outside air and the temperature of the drying air are adjusted without switching the radiation and the heat absorption of the heat exchanger 170, optimum control can easily be performed. Therefore, costs can be reduced.

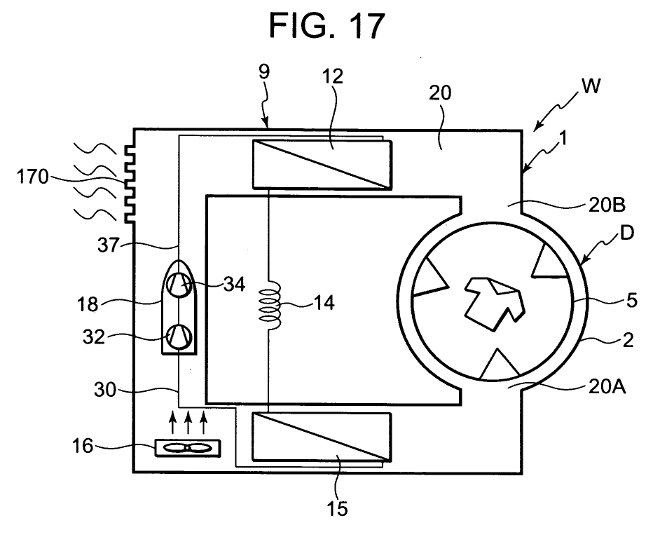

It is to be noted that in the present embodiment, the heat exchanger as the heat exchange means for the heat exchange between the drying air and the air in the air circulation path 20 is disposed in the air circulation path 20 from the downstream side of the evaporator 15 to the upstream side of the compressor 11. The heat exchange means may be disposed at any place between the downstream side of the evaporator 15 and the upstream side of the radiator 12. As shown in FIG. 17, the heat exchange means may be disposed in the air circulation path 20 from the downstream side of the compressor 11 to the upstream side of the radiator 12.

In this case, unlike a case where the heat exchanger 170 is disposed between the downstream side of the evaporator 15 and the upstream side of the compressor 11, it is not possible to obtain a heat absorbing effect that the heat is absorbed from the outside air as the external heat medium in the initial stage of the drying operation and that the temperature of the drying air passed through the evaporator 15 is raised. However, the heat can be discharged to the outside air to eliminate the confinement of the heat, and this can contribute to the reduction of the drying time. Even if the heat exchangers are disposed between the downstream side of the evaporator 15 and the upstream side of the compressor 11 and between the downstream side of the compressor 11 and the upstream side of the radiator 12, the present invention does not have any problem.

Moreover, the washing and drying machine W of the present embodiment is constituted in such a manner that the compressor 11 is disposed in the air circulation path 20. In a case where the compressor 11 is disposed in the air circulation path 20 in this manner, when the air cooled by the evaporator 15, sucked into the fan 16 and discharged is passed through the periphery of the compressor 11, the compressor 11 heated by the operation can be cooled. Furthermore, radiant heat from the compressor 11 itself can be utilized in heating the drying air. In consequence, the temperature rise of the drying air in the initial stage of the drying operation can be promoted.

The present invention is not limited to the above embodiment. In the washing and drying machine W of the present embodiment, the compressor 11 may be disposed in the outside of the air circulation path 20, and the periphery of the compressor 11 may be insulated. In this case, the compressor 11 is heated by the raised temperature of the drying air in the later stage of the drying operation, and the temperature in the compressor 11 rises. In consequence, it is possible to avoid in advance a disadvantage that the rise of the refrigerant temperature is incurred.

It is to be noted that in the present embodiment, as the compressor, the two-stages compression type compressor including the first rotary compression element 32 and the second rotary compression element 34 has been used, but the present invention is not limited to this embodiment. The present invention is effective, even when a compressor including three or more stages of compression elements is used. In the inventions other than the second invention, a single-stage compression type compressor may be used.

Moreover, in the above embodiments, it has been described that carbon dioxide (CO₂) is used as the refrigerant, and the drying machine is operated at a high-pressure side pressure as a supercritical pressure, but the refrigerant usable in the drying machine of the present invention is not limited to this refrigerant. The present invention is effective even in a case where a hydrogen fluoride carbide (HFC)-based refrigerant or the like is used.

What is claimed is:

1. A drying machine which includes a storage chamber to store an object to be dried and which executes a drying operation of the object to be dried in the storage chamber, the drying machine further comprising:
a refrigerant circuit constituted by successively connecting a compressor, a radiator, a pressure reducing unit, an evaporator and the like in an annular form via a pipe;
an air circulation path which allows air sending means to perform air circulation to send air from the radiator through the storage chamber to the evaporator and to again return the air to the radiator; and
heat exchange means for performing heat exchange between an external heat medium and a refrigerant in the refrigerant circuit in a range of a refrigerant outlet of the evaporator to a refrigerant inlet of the radiator.

2. The drying machine according to claim 1, wherein the compressor has an intermediate pressure section; and
the heat exchange means includes an external heat exchanger which performs heat exchange between the external heat medium and the refrigerant of the intermediate pressure section of the compressor.

3. The drying machine according to claim 2, further comprising:
channel control means for controlling whether or not to pass the refrigerant through the external heat exchanger.

4. The drying machine according to claim 3, further comprising:
an internal heat exchanger which causes heat exchange between the refrigerant of the intermediate pressure section of the compressor and the air in the air circulation path,
wherein in a case where any refrigerant is not passed through the external heat exchanger, the refrigerant is passed through the internal heat exchanger.

5. The drying machine according to claim 4, wherein the internal heat exchanger is constituted integrally with the radiator.

6. The drying machine according to claim 1, wherein the heat exchange means includes an external heat exchanger which causes heat exchange between the external heat medium and the refrigerant sucked into the compressor.

7. The drying machine according to claim 6, further comprising:
channel control means for controlling whether or not to pass the refrigerant through the external heat exchanger.

8. The drying machine according to any one of claims 1 to 7, wherein the compressor is disposed in the air circulation path.

9. The drying machine according to any one of claims 1 to 7, wherein the compressor is disposed in the outside of the air circulation path, and a periphery of the compressor is insulated.
